(19) United States
(12) Patent Application Publication
(10) Pub. No.: US 2020/0349609 A1
(43) Pub. Date: Nov. 5, 2020

(54) ELECTRONIC DEVICE AND CONTROL METHOD THEREOF

(71) Applicant: SAMSUNG ELECTRONICS CO., LTD., Suwon-si Gyeonggi-do (KR)

(72) Inventors: Ji-hang SHIN, Seongnam-si (KR); Kwang-su KIM, Hwaseong-si (KR); Jae-wook KIM, Seoul (KR); Ho-gun LIM, Seoul (KR)

(73) Assignee: SAMSUNG ELECTRONICS CO., LTD., Suwon-si Gyeonggi-do (KR)

(21) Appl. No.: 16/956,254

(22) PCT Filed: Aug. 23, 2018
(86) PCT No.: PCT/KR2018/009695

§ 371 Date: Jun. 19, 2020

(30) Foreign Application Priority Data
Dec. 21, 2017 (KR) 10-2017-0176789

(51) Int. Cl. G06Q 30/02; G06F 1/3234

(52) U.S. Cl. CPC G06Q 30/0262; G06F 1/3265; G06Q 30/0252; G06Q 30/0269

(57) ABSTRACT

An electronic device is disclosed. The present electronic device comprises: a display; a communicator; a memory to store computer executable instructions; and a processor for executing computer executable instructions so as to obtain, through the communication unit, state information transmitted by at least one external device, and controlling the display to provide, while the electronic device operates in a standby mode, an image corresponding to an advertising content determined based on the obtained state information.

### TECHNICAL FIELD

This disclosure relates to an electronic device and a controlling method thereof. More particularly, the disclosure relates to an electronic device capable of providing an advertising content at a proper time and a controlling method thereof.

### BACKGROUND ART

With the development of electronic technology, advertising content has been provided to consumers in a variety of ways. For example, an advertisement associated with a program during watching a TV program may be provided in a pop-up form. An advertisement exposed at the time when the user does not want to watch causes the user to feel unpleasant, and the probability of purchasing the corresponding advertisement product would be very low.

As another example, a way of providing advertisement all the time at a specific channel has been used, but in this way, there is a problem in that the advertisement is not delivered unless the user selects the corresponding channel.

Accordingly, there is a need for an advertising method capable of increasing an advertising effect without causing a user to feel unpleasant.

### DISCLOSURE

### Technical Problem

The disclosure is to address the above-described problems, and an object of the disclosure is to provide an electronic device capable of providing advertising content at a proper time and a controlling method thereof.

### Technical Solution

According to an embodiment, an electronic device includes a display, a communicator, a memory configured to store computer executable instructions, and a processor configured to execute computer executable instructions so as to obtain, through the communicator, state information transmitted by at least one external device, and control the display to provide, while the electronic device operates in a standby mode, an image corresponding to an advertising content determined based on the obtained state information.

The standby model may consume lower power than the normal mode, in which the display may not operate, and the communicator may not operate, and when a user input is received while operating in the standby mode, the mode may be switched to a normal mode. When switched to the normal mode, the display may operate, and an application that has been executed before the electronic device enters the standby mode may be executed.

The standby mode may be a state in which a designated application or widget operate, and an image corresponding to the advertising content may be displayed with an image by the application or widget, or an image corresponding to the advertising content may be displayed instead of an image by the application or widget. When a user input is received while operating in the standby mode, the mode may be switched to the normal mode. When switched to the normal mode, the display may operate, and an application that has been executed before the electronic device enters the standby mode may be executed.

The processor may provide, through the communicator, the obtained state information to an external server, and based on receiving the determined advertising content from the external server based on the obtained state information, control the display to provide an image corresponding to the received advertising content.

The image corresponding to the advertising content may be provided through the display at a time determined by the external server based on the obtained state information.

The advertising content may correspond to a user context determined by analyzing the obtained state information by the external server.

The processor may, based on receiving a preset user input while the image corresponding to the advertising content is provided through the display, switch the electronic device to a normal mode and control the display to provide other image corresponding to the advertising content.

The standby mode may provide an image corresponding to the advertising content with lower power than the normal mode.

The image corresponding to the advertising content provided in the standby mode may include brief information for the advertising content, and other image corresponding to the advertising content provided in the normal mode may include detailed information for the advertising content.

The image corresponding to the advertising content provided in the standby mode may include an icon, and the processor may, based on the icon being selected, switch the electronic device to a normal mode, and control the display to provide the other image corresponding to the advertising content.

The at least one external device may include at least one device selected from a group consisting of a door sensor, a motion sensor, a temperature sensor, an illuminance sensor, a humidity sensor, a drapery sensor, a gas sensor, a lighting device, and a device for requesting a hotel service.

The advertising content may be determined based on personal information of a user of the electronic device.

According to an embodiment, a control method of an electronic device includes obtaining state information transmitted by at least one external device, and controlling a display of the electronic device to provide, while the electronic device operates in a standby mode, an image corresponding to an advertising content determined based on the obtained state information.

The method may further include providing the obtained state information to an external server, and the controlling the display may include, based on receiving the determined advertising content from the external server based on the obtained state information, controlling the display to provide an image corresponding to the received advertising content.

The image corresponding to the advertising content may be provided through the display at a time determined by the external server based on the obtained state information.

The advertising content may correspond to a user context determined by analyzing the obtained state information by the external server.

The control method of the electronic device according to an embodiment may further include, based on receiving a preset user input while the image corresponding to the advertising content is provided through the display, switching the electronic device to a normal mode, and controlling the display to provide other image corresponding to the advertising content in the normal mode.

The standby mode may provide an image corresponding to the advertising content with lower power than the normal mode.

The image corresponding to the advertising content provided in the standby mode may include brief information for the advertising content, and other image corresponding to the advertising content provided in the normal mode may include detailed information for the advertising content.

The image corresponding to the advertising content provided in the standby mode may include an icon, and the switching may include switch the electronic device to a normal mode, based on the icon being selected.

The at least one external device may include at least one device selected from a group consisting of a door sensor, a motion sensor, a temperature sensor, an illuminance sensor, a humidity sensor, a drapery sensor, a gas sensor, a lighting device, and a device for requesting a hotel service.

The advertising content may be determined based on personal information of a user of the electronic device.

### DESCRIPTION OF DRAWINGS

FIG. 1 is a diagram illustrating a system according to an embodiment;

FIG. 2 is a block diagram illustrating a configuration of an electronic device according to an embodiment;

FIG. 3 is a view illustrating an operation mode of an electronic apparatus according to an embodiment;

FIG. 4 is a view illustrating an advertising content providing method in a standby mode and a normal mode of an electronic apparatus according to an embodiment;

FIG. 5 is a view illustrating an embodiment in which a system according to the disclosure is applied to home;

FIG. 6 is a block diagram illustrating a configuration of a server according to an embodiment;

FIG. 7 is a view illustrating an embodiment in which the system according to the disclosure is applied to a hotel;

FIG. 8 is a view illustrating an embodiment in which the system according to the disclosure is applied to a hotel;

FIG. 9 is a flowchart illustrating a controlling method of an electronic device according to an embodiment; and

FIG. 10 is a view illustrating a user interface (UI) provided by an electronic device according to an embodiment.

### DETAILED DESCRIPTION OF EXEMPLARY EMBODIMENTS

Hereinafter, embodiments of the disclosure will be described with reference to the accompanying drawings. However, it may be understood that the disclosure is not limited to the embodiments described hereinafter, but include various modifications, equivalents, and alternatives of the embodiments of the disclosure. For the description of the drawings, similar reference numerals may be used for similar constituent elements.

In the disclosure, the term “has,” “may have,” “includes” or “may include” indicates existence of a corresponding feature (e.g., a numerical value, a function, an operation, or a constituent element such as a component), but does not exclude existence of an additional feature.

In the disclosure, the term “A or B,” “at least one of A or/and B,” or “one or more of A or/and B” may include all possible combinations of the items that are enumerated together. For example, the term “A or B”, “at least one of A and B”, or “at least one of A or B” may designate (1) at least one A, (2) at least one B, or (3) both at least one A and at least one B.

In the disclosure, the terms “first, second, etc.” may be used to describe various elements regardless of their order and/or importance and to discriminate one element from other elements, but are not limited to the corresponding elements. For example, a first user device and a second user device may indicate different user devices regardless of a sequence or importance thereof. For example, the first component may be named the second component and the second component may also be similarly named the first component, without departing from the scope of the disclosure.

If it is described that an element (e.g., first element) is “operatively or communicatively coupled with/to” or is “connected to” another element (e.g., second element), it may be understood that the element may be connected to the other element directly or through still another element (e.g., third element). When it is mentioned that one element (e.g., first element) is “directly coupled” with or “directly connected to” another element (e.g., second element), it may be understood that there is no element (e.g., third element) present between the element and the other element.

Herein, the expression “configured to” may be used interchangeably with, for example, “suitable for”, “having the capacity to”, “designed to”, “adapted to”, “made to”, or “capable of”. The expression “configured to” does not necessarily mean “specifically designed to” in a hardware sense. Instead, under some circumstances, “a device configured to” may indicate that such a device may perform an operation along with another device or part. For example, the expression “a processor configured to perform A, B, and C” may indicate an exclusive processor (e.g., an embedded processor) to perform the corresponding operation, or a generic-purpose processor (e.g., a central processor (CPU) or application processor (AP)) that may perform the corresponding operations by executing one or more software programs stored in the memory device.

Terms used in the disclosure may be used to describe specific embodiments rather than restricting the scope of other embodiments. Singular forms are intended to include plural forms unless the context clearly indicates otherwise. Terms used in the disclosure including technical and scientific terms may have the same meanings as those that are generally understood by those skilled in the art to which the disclosure pertains. Terms defined in a general dictionary among terms used in the disclosure may be interpreted as meanings that are the same as or similar to meanings within a context of the related art, and are not interpreted as ideal or excessively formal meanings unless clearly defined in the disclosure. In some cases, terms may not be interpreted to exclude embodiments of the disclosure even where they may be defined in the disclosure.

The electronic devices according to various embodiments may include at least one of, for example, smartphones, tablet personal computer (PC)s, mobile phones, video telephones, artificial intelligence (AI) speaker, electronic book readers, desktop PCs, laptop PCs, netbook computers, workstations, servers, a personal digital assistant (PDA), a portable multimedia player (PMP), a moving picture experts group phase 1 or phase 2 (MPEG-1 or MPEG-2) audio layer 3 (MP3) player, a mobile medical device, a camera, or a wearable device. According to various embodiments, a wearable device may include at least one of an accessory type (e.g., a watch, a ring, a bracelet, an ankle bracelet, a necklace, a pair of glasses, a contact lens or a head-mounted-device (HMD)); a fabric or a garment-embedded type (e.g. electronic cloth); skin-attached type (e.g., a skin pad or a tattoo); or a bio-implantable circuit.

In some embodiments, the electronic device may be a home appliance. In some embodiments, the home appliance may include at least one of, for example, a television, a digital video disk (DVD) player, an audio system, a refrigerator, air-conditioner, a cleaner, an oven, a microwave, a washing machine, an air purifier, a set top box, a home automation control panel, a security control panel, a TV box (e.g., SAMSUNG HOMESYNC™, APPLE TV™, or GOOGLE TV™), a game console (e.g., XBOX™, PLAYSTATION™), an electronic dictionary, an electronic key, a camcorder, or an electronic frame.

In other embodiments, the electronic device may include at least one of a variety of medical devices (e.g., various portable medical measurement devices such as a blood glucose meter, a heart rate meter, a blood pressure meter, or a temperature measuring device), magnetic resonance angiography (MRA), magnetic resonance imaging (MRI), computed tomography (CT), or ultrasonic wave device, etc.), a navigation system, a global navigation satellite system (GNSS), an event data recorder (EDR), a flight data recorder (FDR), an automotive infotainment devices, a marine electronic equipment (e.g., marine navigation devices, gyro compasses, etc.), avionics, a security device, a car head unit, industrial or domestic robots, a drone, an automated teller machine (ATM), a point of sale of a store, or an Internet of Things (IoT) device (e.g., light bulbs, sensors, sprinkler devices, fire alarms, thermostats, street lights, toasters, exercise equipment, hot water tanks, heater, boiler, etc.).

In another embodiment, the electronic device may include at least one of a furniture, a portion of a building/structure, an electronic board, an electronic signature receiving device, a projector, or various metrology instruments (e.g., water, electricity, gas, or radio wave measuring equipment, or the like). The electronic device according to various embodiments may be one or a combination of the aforementioned various devices. The electronic device according to an embodiment may be a flexible electronic device. The electronic device according to an embodiment may include an electronic device that is connected to the external Internet through connection with a network equipment, such as an access point, a gateway, a router, a switch, or the like, and may include a new electronic device in accordance with the technology development.

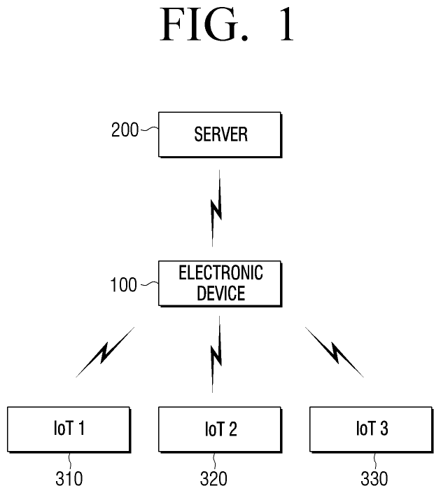

An electronic device according to various embodiments will be described with reference to the accompanying drawings. FIG. 1 is a system configuration diagram according to an embodiment. Referring to FIG. 1, an electronic device 100, a server 200, and a plurality of devices 310, 320, 330 are illustrated. Although three devices are shown as an example, the number of devices in the system is not limited thereto, and one or more devices may be included.

The plurality of devices 310, 320, 330 may include a communicator and may transmit state information to the electronic device 100 as an event occurs. The plurality of devices 310, 320, 330 may be Internet of Things (IoT) devices and may operate by a user's manipulation or may operate automatically when a given condition is satisfied. The plurality of devices 310, 320, 330 may be located at a place, such as homes, hotels, companies, factories, or the like.

The plurality of devices 310, 320, 330 may include at least one of several types of sensors. For example, the plurality of devices 310, 320, 330 may include at least one of a door sensor (a sensor that senses opening and closing of various doors, for example, a sensor that senses opening and closing of a front door, a sensor that senses opening and closing of a refrigerator door, or the like), a drapery sensor (a sensor that senses opening and closing of a drapery) a motion sensor, a temperature sensor, an illuminance sensor, a humidity sensor, a power detection sensor, a gas sensor, a smoke sensor, or a moisture sensor. These sensors may sense a human motion or sense a particular change in the external environment and output data. The data may include state information of a device. For example, the door sensor may output data when it is sensed that the user opens the door. The motion sensor may output data when sensing the movement of the user. The temperature sensor may output data when the external environment approaches a predetermined temperature. The power detection sensor may be connected to a power outlet and may output data if the power of the device connected to the outlet is turned on. When the illuminance sensor is attached to a room, whether the room is lighted or not may be identified based on the data outputted from the illuminance sensor.

The plurality of devices 310, 320, 330 may be located within the hotel room, and may include, for example, a service requesting device located within the hotel room. The user may request to make up room or not to disturb by manipulating the service requesting device. The service requesting device may receive a user manipulation for requesting a service and notify a hotel system of the content for the service requested by the user to enable a hotel staff to identify (or check) the requested service. The service requesting device may be implemented as a remote controller, a tablet personal computer (PC), or the like, disposed within the hotel room. Alternatively, the service requesting device may be a sign device that displays a letter, such as a “Make Up Room” or “Do Not Disturb”, and this device may be located outside a door so that a hotel staff may identify. When a user requests a service by using the service requesting device, the service requesting device may output data. The data may include state information of the service requesting device, that is, information indicative of what is the requested service.

The plurality of devices 310, 320, 330 may include a lighting device. When the lighting device is turned on or turned off, data may be output. The output data may include state information indicating that the lighting device is in a turned-on state or a turned-off state.

In addition to the aforementioned examples, the plurality of devices 310, 320, 330 may be implemented as any device equipped with a communication function.

The plurality of devices 310, 320, 330 may include a communicator and the state information transmitted by the devices 310, 320, and 330 may be received by the electronic device 100. The state information may include an intrinsic identification (ID) of the device. The intrinsic ID of the device may be preset when the device is manufactured.

The electronic device 100 may include a communicator and may receive state information transmitted by the plurality of devices 310, 320, 330 through the communicator. The electronic device 100 may transmit state information received from the plurality of devices 310, 320, and 330 to the server 200 through the communicator. The electronic device 100 may transmit its own state information as well as the state information received from the plurality of devices 310, 320, 330 to the server 200. For example, information associated with a current operating mode of the electronic device 100 may be transmitted to the server 200. The electronic device 100 may transmit additional information along with the state information to the server 200. For example, information regarding the time at which the state information is received, information about a location of the device that transmitted the state information, or the like, may be added to the server 200.

When communicating with the plurality of devices 310, 320, and 330, the electronic device 100 may use communication of a first type and when communicating with the server 200, the electronic device 100 may use communication of a second type. For example, ZigBee may be used for communications between the electronic device 100 and the plurality of devices 310, 320, 330, and Ethernet may be used for communications between the electronic device 100 and the server 200. The electronic device 100 may collect data received from the plurality of devices 310, 320, 330 and transmit the data to the server 200.

The server 200 may store various advertising contents and provide the advertising contents to the electronic device 100. In this example, the server 200 may identify (or determine) whether it is a proper context that the advertising content is to be provided based on the data received from the electronic device 100. A proper context that the advertising content is to be provided may be, for example, a context where the user is awakened from sleeping. Conversely, an improper context where the advertising content is to be provided may be, for example, a context where the user is sleeping. These contexts may be identified based on the state information output from the plurality of devices 310, 320, 330. For example, when the drapery sensor of the devices 310, 320, 330 transmits state information to the electronic device 100 in response to the occurrence of an event in which the drapery is opened in the morning, and the electronic device 100 transmits the state information to the server 200, the server 200 may identify that the user awakes from sleeping based on the received state information. In another example, when a motion is detected by the motion sensor, among the plurality of devices 310, 320, 330, disposed in the bedroom is sensed by the motion sensor disposed in the bedroom, and when an event that a lighting device located in the bed room is lighted off occurs, the motion sensor and the lighting device may transmit the state information to the electronic device 100, in response to the event occurrence, the electronic device 100 may transmit state information to the server 200, and the server 200 may identify that the user is sleeping based on the state information received from the electronic device 100.

If it is identified that it is a proper context to provide the advertising content, the server 200 may provide the advertising content to the electronic device 100. The advertising content provided to the electronic device 100 may be advertising content determined on the basis of the state information received from the electronic device 100. For example, if it is identified that the user awakes from sleeping based on the state information received from the electronic device 100, the server 200 may determine advertising content related to a morning meal menu as advertising content to be provided to the electronic device 100.

Alternatively, the server 200 may determine advertising content based on personal information of the user of the electronic device 100. For example, the server 200 may store personal information about the user, such as occupation, nationality, matters of interest, or the like, of a user of the electronic device 100, and may determine the advertising content to be provided to the electronic device 100 based on the personal information.

The server 200 may determine an advertising content in consideration of state information received from the electronic device 100 and the personal information of the user of the electronic device 100.

The server 200 may transmit the determined advertising content to the electronic device 100. The electronic device 100 may provide the received advertising content. According to an embodiment, the advertising content provided from the server 200 may be provided while the electronic device 100 is in a standby mode.

Although the server 200 of FIG. 1 is shown as one, it is an example only, and the serve 200 may be implemented as a plurality of servers. The server 200 of FIG. 1 is described as an external device of the electronic device 100, but this is an example only, and according to another example, the server 200 may be embedded in the electronic device 100. In this example, the operation of the electronic device 100 to transmit data to the server 200 and receive the advertising content is omitted and the operation of the server 200 described above may be performed by the electronic device 100 itself

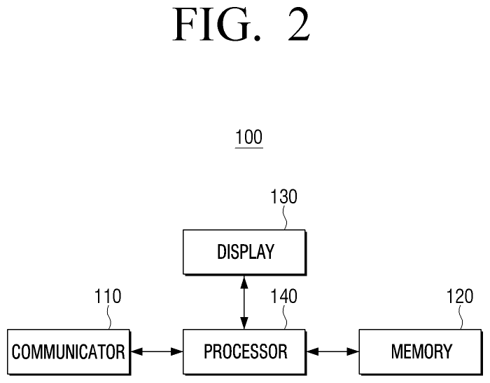

FIG. 2 is a block diagram illustrating a configuration of the electronic device 100 according to an embodiment.

Referring to FIG. 2, the electronic device 100 may include a communicator 110, a memory 120, and a display 130.

The communicator 110 is configured to communicate with an external device. The communicator 110 may communicate with at least one external devices 310, 320, 330. The communicator 110 may communicate with the server 200.

The communicator 110 may be connected to network via wireless communication or wired communication and may communicate with at least one external device 310, 320, 330 or the server 200. Wireless communication may include cellular communication using any one or any combination of the following, for example, long-term evolution (LTE), LTE advanced (LTE-A), a code division multiple access (CDMA), a wideband CDMA (WCDMA), and a universal mobile telecommunications system (UMTS), a wireless broadband (WiBro), or a global system for mobile communications (GSM), and the like. Wireless communication may include, for example, local area network. The local area network may include at least one of, for example, wireless fidelity direct (WiFi direct), Bluetooth, near field communication (NFC), or ZigBee. Wired communication may include at least one of, for example, a universal serial bus (USB), a high definition multimedia interface (HDMI), a recommended standard 232 (RS-232), or a plain old telephone service (POTS). The network may include at least one of a telecommunications network, for example, a computer network (for example, local area network (LAN) or wide area network (WAN)), the Internet, or a telephone network.

The communicator 110 may include, for example, a cellular module, a WiFi module, a Bluetooth module, a global navigation satellite system (GNSS) module (for example: global positioning module (GPS) module, Glonass module, Beidou module, or Galileo module), NFC module, and a radio frequency (RF) module.

The cellular module may provide, for example, voice calls, video calls, text services, Internet services, or the like, via a communication network. According to one embodiment, the cellular module may use a subscriber identification module (e.g., a subscriber identification module (SIM) card) to perform discrimination and authentication of the electronic device within the communication network. According to one embodiment, the cellular module may perform at least some of the functions which may be provided by the processor. According to one embodiment, the cellular module may include a communication processor (CP).

Each of the WiFi module, the Bluetooth module, the GNSS module, or the NFC module may include, for example, a processor for processing data transmitted and received via a corresponding module. According to some embodiments, at least a portion (e.g., two or more) of the cellular module, the WiFi module, the Bluetooth module, the GNSS module, or the NFC module may be included in one integrated chip (IC) or an IC package.

The RF module may, for example, transmit and receive a communication signal (e.g., an RF signal). The RF module may include, for example, a transceiver, a power amp module (PAM), a frequency filter, a low noise amplifier (LNA), or an antenna. According to another embodiment, at least one of the cellular module, the WiFi module, the Bluetooth module, the GNSS compliant module, or the NFC module may transmit and receive the RF signal through a separate RF module.

The memory 120 may include, for example, an internal memory or an external memory. The internal memory may include, for example, a volatile memory, such as a dynamic random access memory (DRAM), a static random access memory (SRAM), a synchronous dynamic random access memory (SDRAM), or a nonvolatile memory, such as one-time programmable ROM (OTPROM), programmable ROM (PROM), erasable and programmable ROM (EPROM), electrically erasable and programmable ROM (EEPROM), mask ROM, flash ROM, a flash memory (for example, NAND flash or NOR flash), a hard disk drive or a solid state drive (SSD).

The external memory may include a flash drive (for example, a compact flash (CF), secure digital (SD), micro secure digital (micro-SD), mini secure digital (mini-SD), extreme digital (xD), multi-media card (MMC), and etc.), a memory stick, or the like. The external memory may be connected to the electronic device 100 functionally and/or physically through various interfaces.

The memory 120 may store computer executable instructions.

The display 130 may include, for example, a liquid crystal display (LCD), a light-emitting diode (LED) display, an organic light-emitting diode (OLED), display (for example, active-matrix organic light-emitting diode (AMOLED), passive-matrix OLED (PMOLED), or microelectromechanical systems (MEMS) display, or an electronic paper display.

The display 130 may display various images. For example, the display 130 may display an image including a text, an image, a video, an icon, or a symbol. The display 130 may display a user interface (UI) object.

The display 130 may include a touch screen, for example, may receive touch, gesture, proximity, or hovering input using a part of a user's body or an electronic pen.

The electronic device 100 may include various configurations for receiving a user input. For example, a button for receiving user manipulation, a microphone for receiving user voice commands, a motion sensor or camera for receiving user gesture commands, and the like, may be included. The electronic device 100 may receive a signal corresponding to a user input from an external device. For example, the electronic device 100 may receive a control signal from an external device (e.g., remote controller, smartphone, or the like) using Bluetooth, IR communications, or the like.

The processor 140 is configured to control overall operations of the electronic device 100. For example, the processor 140 may control a plurality of hardware or software elements connected to the processor 140 by driving an operating system or an application program and perform various data processing and calculations. The processor 140 may be implemented as, for example, a system on chip (SoC). According to an embodiment, the processor 140 may further include a graphic processing unit (GPU) and/or an image signal processor. The processor 140 may perform an operation of the electronic device 100 according to various embodiments by executing computer-executable instructions stored in the memory 120.

The processor 140 may provide an image corresponding to the advertising content received from the server 200 through the display 130. According to one embodiment, the processor 140 may provide an image corresponding to the advertising content provided from the server 200 regardless of operating modes of the electronic device 100. According to another embodiment, the processor 140 may provide an image corresponding to the advertising content only when the operating mode of the electronic device 100 is a standby mode, and may not provide the corresponding image if the operating mode of the electronic device 100 is not the standby mode.

The electronic device 100 may operate in a plurality of operating modes including a normal mode and a standby mode and each mode may be divided according to a level of power consumption. The standby mode consumes less power compared to the normal mode.

According to one embodiment, the standby mode is in a state that less power is consumed than the normal mode, where the display 130 may not operate, and the communicator 110 may operate. When the advertising content is received through the communicator 110 while operating in the standby mode, the processor 140 may control the display 130 to display an image corresponding to the advertising content at low power. According to one embodiment, the display 130 may be implemented with an active OLED (AMOLED) display. The active OLED display may emit light by each pixel without a backlight. In the AMOLED method, when representing black, a current is not flown to an LED so that no color is expressed. The AMOLED may reduce power consumption as compared to other display schemes in an example where most of the image is in black color.

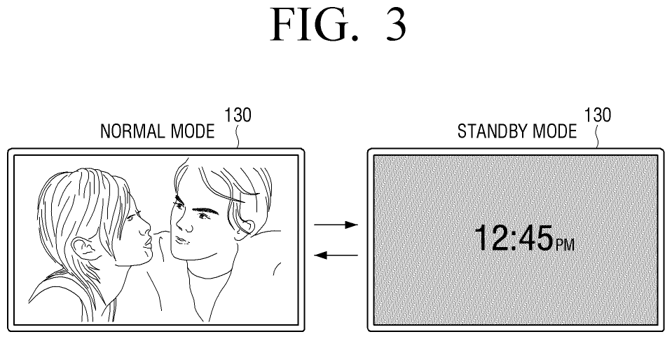

If the display 130 is the AMOLED display, the standby mode according to one embodiment may be a mode that displays an image with a black background. For example, as illustrated in FIG. 3, when the normal mode is switched to the standby mode, the current is supplied to only the pixels of the portion where the specific information (e.g., time) to be displayed is represented in the standby mode, and the current is not supplied to the remaining pixels to represent the black background.

The processor 140 may provide an image corresponding to the advertising content at low power by controlling the display 130 to display an image corresponding to the advertising content having a black background as described above.

According to another embodiment, the normal mode and the standby mode may be divided by a frame frequency when an image is provided through the display 130. The frame frequency of the standby mode may be set to be relatively lower than the frame frequency of the normal mode.

According to another embodiment, in the normal mode, a variety of image processing is performed, for example, the noise of the image data is removed to improve the quality of the image, the contrast ratio is optimized, the color sense is increased, and the image quality is improved, while at least one of the image processing performed in the normal mode may not be performed in the standby mode. As another example, the display area of the standby mode may be small compared to the normal mode. That is, in the standby mode, the image is displayed only in a partial area of the display 130 so that power consumption may be reduced by not using the remaining area.

The processor 140, when switched to a normal mode, operate the display 130 and execute an application which has been executed prior to entering the standby mode.

According to an embodiment, the standby mode may be a state in which a designated application or widget operate, and the processor 140 may control the display 130 to display an image corresponding to the advertising content with an image by the application or widget, or to display an image corresponding to the advertising content instead of an image by the application or widget. When a user input is received while operating in the standby mode, the mode may be switched to the normal mode. When switched to the normal mode, the processor 140 may operate the display 130 and execute an application that has been executed before the electronic device 100 enters the standby mode.

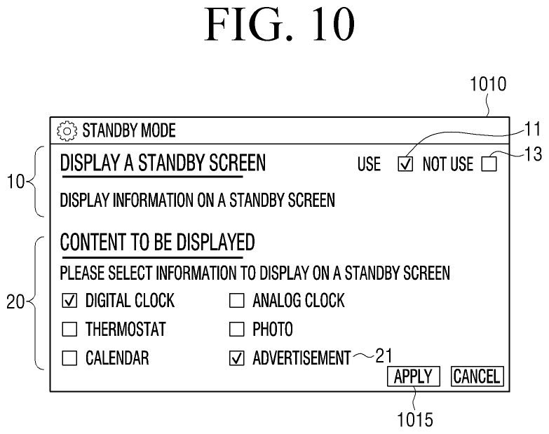

Information on an application or widget to be executed in the standby mode may be stored in the memory 120, and the information may be changed by the user. For example, the processor 140 may control the display 130 to display an UI for receiving a selection of an application or widget to be executed in the standby mode, and the user may select the desired application or widget via the UI. An example of the UI is shown in FIG. 10.

FIG. 10 is a view illustrating a user interface (UI) provided by the electronic device 100 according to an embodiment.

Referring to FIG. 10, a UI 1010 for setting related to a screen display in a standby mode may be provided. The UI 1010 may include a menu 1011 for selecting whether to use a screen display function in a standby mode. If the user selects and sets a menu item 11 corresponding to “use”, the specific information may be displayed on the screen in the standby mode, and if the user selects and sets a menu item 13 corresponding to “not use”, no information is displayed on the screen in the standby mode.

The UI 1010 may include a menu 20 for selecting an application or widget to execute in the standby mode. An image corresponding to the selected item in the menu 20, such as a digital clock widget, an analog clock widget, a thermometer widget, a photo widget, a calendar widget, an advertisement widget, or the like, may be displayed in the standby mode. If a menu item 21 corresponding to the advertisement is selected and set, an image corresponding to the advertising content may be provided in the standby mode, as described above.

When the user completes selection through the UI 1010 and selects an application button 1015, the set information through the UI 1010 may be stored in the memory 120.

The processor 130 may switch the mode of operation of the electronic device 100 from a normal mode to a standby mode when a predetermined user input is received. For example, when a user selects a specific button (a hardware button or a button on a touch screen) provided in the electronic device 100, the normal mode may be switched to the standby mode. As another example, when a user selects a specific button (a hardware button or a button on a touch screen) provided on an external device (e.g., a remote controller, a smartphone, etc.) wirelessly connected to the electronic device 100, a control signal corresponding to the button may be output to the electronic device 100 and received by the electronic device 100, the normal mode may be switched to the standby mode. For example, if the power button provided in the remote controller is selected, the electronic device 100 may be switched from the normal mode to the standby mode. In addition to a method for manipulating the button, by using various controlling methods, such as motion, voice, etc., the normal mode may be switched to the standby mode. Switching from the standby mode to the normal mode is also possible.

In addition to the aforementioned examples defining the normal mode and the standby mode, any case in which a plurality of modes can be divided in a perspective of power consumption may be included in the disclosure.

The terms of the normal mode and the standby mode used herein are merely to distinguish different operating modes, and the disclosure is not limited to a lexical meaning of the terms. Instead of the terms of normal mode and standby mode, a first mode, a second mode, a first state, or a second state may be used.

According to an embodiment, when advertising content is provided from the server 200, the processor 130 may provide an image corresponding to the advertising content through the display 130 only when the operation mode is in the standby mode. That is, according to the embodiment, the electronic device 100 has an authority to determine whether to provide an image corresponding to the advertising content through the display 130.

According to another embodiment, the electronic device 100 may transmit state information indicating its operation mode to the server 200, to determine whether the operating mode of the electronic device 100 is the standby mode at the server 200, and provide the advertising content to the electronic device 100 only when the mode is the standby mode. That is, according to the embodiment, the server 200 has an authority to determine whether to provide an image corresponding to the advertising content through the display 130, and the electronic device 100 simply displays an image of the advertising content provided from the server 200.

As described above, according to embodiments of providing the advertising content by classifying the normal mode and the standby mode, the advertising content is not provided while the user watches the desired content, such as a soap opera, a movie, etc. in the normal mode, and thus the user's watching of the desired content may not be hindered.

According to an embodiment, when a predetermined user input is received while the processor 140 provides an image corresponding to the advertising content through the display 130 in the standby mode, the processor 140 may control the display 130 to convert the electronic device 100 into a normal mode and provide another image corresponding to the advertising content.

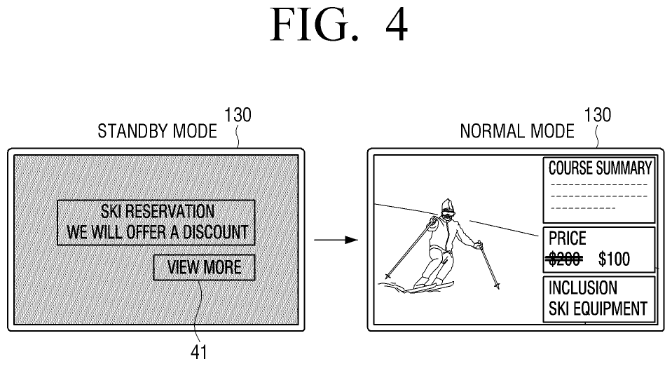

In the normal mode, more detailed advertising content than the standby mode may be provided. For example, referring to FIG. 4, the image corresponding to the advertising content for the ski reservation provided in the standby mode may include only the brief information for the ski reservation. When converted into the normal mode, the image corresponding to the advertising content for the ski reservation may include detailed information about the ski reservation.

The reference for dividing brief information and detailed information is display amount of information or types of information. The types of information may include text information, image (still image or moving image) information, sound information, or the like. For example, the brief information is information including only the text, and the detailed information may be information including text information and image information. As another example, the brief information may include visual information, such as text, images, and the like, and the detailed information may include visual information and sound information.

In the standby mode, when a preset user input is received while an image corresponding to the advertising content is being provided, the standby mode may be switched to the normal mode, and here, the preset user input can be, for example, selecting an icon included in an image corresponding to the advertising content provided in the standby mode. For example, as illustrated in FIG. 4, the image corresponding to the advertising content provided in the standby mode may include an icon 41, and when the user input selecting the icon 41 is received, the standby mode may be switched to the normal mode. The selection of the icon 41 may vary depending on the implementation of the electronic device 100. For example, if the display 130 is implemented as a touch screen, the standby mode may be switched to the normal mode upon receiving a user input touching the icon 41. As another example, if the electronic device 100 is a device that can be controlled according to voice, a voice “view more” may be input through a microphone provided in the electronic device 100, and when a voice command corresponding thereto is received by the electronic device 100, the electronic device 100 may be switched to the normal mode. As another example, an external device such as a remote controller may be manipulated by a user to select the icon 41.

As the above embodiment, advertisements with different contents may be provided in the standby mode and the normal mode and according to a still another embodiment, the content of advertisement provided in the standby mode and the normal mode may be the same, but quality of image may be different, a frame rate of providing an image may be different, or the size of image may be different.

According to another embodiment, advertising content may be provided only if the electronic device 100 is in standby mode while a particular context is satisfied. For example, advertising content may be provided only when a user is expected to be interested in the advertisement. A time point for providing advertising content may be determined according to a user context. The user context may be determined based on the state information of the plurality of devices 310, 320, 330.

For example, if a context in which a user enters inside the house from outside the house and moves to a living room is identified, and the electronic device 100 is in the standby mode, the advertising content may be provided through the electronic device 100.

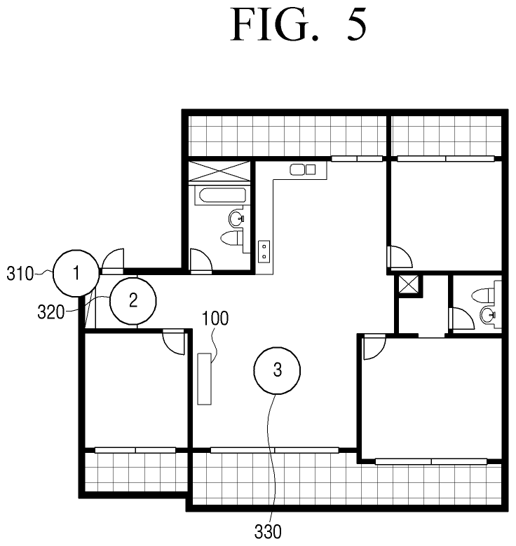

FIG. 5 is a diagram illustrating a state in which the electronic device 100 and a plurality of devices 310, 320, 330 disposed therein are disposed. Referring to FIG. 5, circles 310, 320, and 330 schematically illustrate an actual position of the device disposed in the house. The number inside the circle may be the intrinsic identification (ID) of the device. The intrinsic ID of the device may be assigned upon manufacturing the device. The plurality of devices 310, 320, 330 are sensors for sensing motion of a person or object, and when motion is sensed, the plurality of devices 310, 320, 330 may transmit state information to the electronic device 100. The state information may include information about the context in which the sensor is sensed, the ID of the sensor, or the like. For example, if a motion is detected when the device is a motion sensor, state information may be transmitted to the electronic device 100. When the device is a door sensor, the state information may be transmitted to the electronic device 100 when the door is open.

The electronic device 100 may receive state information from the plurality of devices 310, 320, 330 and transmit the state information to the server 200. The server 200 may analyze the data to determine the user's context in the house. For example, the user may transmit state information to the electronic device 100 when the user opens the front door. The state information may be transmitted from a device 320 when the user closes the front door and enters the home, and the state information may be transmitted from the device 330 when the user moves to the living room. The server 200 may determine that the user has entered into the house and moved to the living room based on the order of the state information transmitted by the devices 310, 320, and 330. If the determined user context is a context suitable for providing an advertisement, the server 200 may provide the advertising content to the electronic device 100. The provided advertising content may also be determined based on the user context. For example, the server 200 may provide, to the electronic device 100, advertising content including sentences, “the weather is so cold outside, so A Department Store is selling ultra-light jumper at a discounted price” to the electronic device 100. The processor 140 may control the display 130 to display an image corresponding to the advertising content while operating in the standby mode.

As another example, if motion is detected through the sensor 330 in the living room in the evening hours and if the electronic device 100 is in the standby mode, the advertising content may be provided, as it is determined that it is the context suitable for providing the advertisement. For example, advertising content for a restaurant that provides an evening meal may be provided.

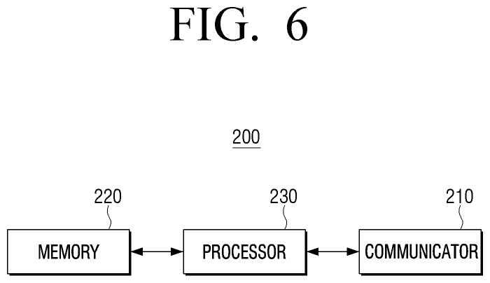

FIG. 6 is a diagram illustrating a configuration of the server 200 according to an embodiment.

Referring to FIG. 6, the server 200 includes a communicator 210, a memory 220, and a processor 230.

The communicator 210 is configured to communicate with an external device. The communicator 210 may communicate with the external device 100.

The communicator 210 may be connected to network via wireless communication or wired communication and may communicate with the external device 100. Wireless communication may use, for example, cellular communication protocol, any one of, for example, long-term evolution (LTE), LTE advanced (LTE-A), a code division multiple access (CDMA), a wideband CDMA (WCDMA), and a universal mobile telecommunications system (UMTS), a wireless broadband (WiBro), or a global system for mobile communications (GSM), and the like. The wireless communication may include, for example, local area network. Local area network may include at least one of, for example, wireless fidelity direct (WiFi direct), Bluetooth, near field communication (NFC), or ZigBee. Wired communication may include, for example, a universal serial bus (USB), a high definition multimedia interface (HDMI), a recommended standard 232 (RS-232), or a plain old telephone service (POTS). The network may include at least one of a telecommunications network, for example, a computer network (for example, local area network (LAN) or wide area network (WAN)), the Internet, or a telephone network.

The communicator 210 may include, for example, a cellular module, a WiFi module, a Bluetooth module, a global navigation satellite system (GNSS) module (for example: global positioning module (GPS) module, Glonass module, Beidou module, or Galileo module), NFC module, and a radio frequency (RF) module.

The cellular module may provide, for example, voice calls, video calls, text services, Internet services, or the like, via a communication network. According to one embodiment, the cellular module may use a subscriber identification module (e.g., a subscriber identification module (SIM) card) to perform discrimination and authentication of the electronic device within the communication network. According to one embodiment, the cellular module may perform at least some of the functions which may be provided by the processor. According to one embodiment, the cellular module may include a communication processor (CP).

Each of the WiFi module, the Bluetooth module, the GNSS module, or the NFC module may include, for example, a processor for processing data transmitted and received via a corresponding module. According to some embodiments, at least a portion (e.g., two or more) of the cellular module, the WiFi module, the Bluetooth module, the GNSS module, or the NFC module may be included in one integrated chip (IC) or an IC package.

The RF module may, for example, transmit and receive a communication signal (e.g., an RF signal). The RF module may include, for example, a transceiver, a power amp module (PAM), a frequency filter, a low noise amplifier (LNA), or an antenna. According to another embodiment, at least one of the cellular module, the WiFi module, the Bluetooth module, the GNSS compliant module, or the NFC module may transmit and receive the RF signal through a separate RF module.

The memory 220 may include, for example, an internal memory or an external memory. The internal memory may include, for example, a volatile memory, such as a dynamic random access memory (DRAM), a static random access memory (SRAM), a synchronous dynamic random access memory (SDRAM), or a nonvolatile memory, such as one-time programmable ROM (OTPROM), programmable ROM (PROM), erasable and programmable ROM (EPROM), electrically erasable and programmable ROM (EEPROM), mask ROM, flash ROM, a flash memory (for example, NAND flash or NOR flash), a hard disk drive or a solid state drive (SSD).

The external memory may include a flash drive (for example, a compact flash (CF), secure digital (SD), micro secure digital (micro-SD), mini secure digital (mini-SD), extreme digital (xD), multi-media card (MMC), and etc.), a memory stick, or the like. The external memory may be connected to the server 200 functionally and/or physically through various interfaces.

The memory 220 may store computer executable instructions.

The processor 230 is configured to control overall operations of the server 200. For example, the processor 230 may control a plurality of hardware or software elements connected to the processor 230 by driving an operating system or an application program and perform various data processing and calculations. The processor 230 may be implemented as, for example, a system on chip (SoC). The processor 230 may perform an operation of the server 200 according to various embodiments by executing computer-executable instructions stored in the memory 220.

The memory 220 may store advertising content. The processor 230 may analyze features of the advertising content stored in the memory 220 and store the feature information in the memory 220. The feature information of the advertising content may be used to provide a customized advertisement according to a user context.

The processor 230 may identify a user context based on the state information of the devices 310, 320, 330 received from the electronic device 100 through the communicator 210, and determine the advertising content. The memory 220 may store personal information such as age, educational background, occupation, a matter of interest, or the like, of the user of the electronic device 100, and the processor 230 may determine the advertising content based on the user's personal information.

The processor 230 may determine the time of providing the determined advertising content based on the state information of the devices 310, 320, 330 received from the electronic device 100 and the state information of the electronic device 100. For example, the server 200 may receive the state information of the devices 310, 320, 330 and the state information of the electronic device 100 in real time via the communicator 210, and may provide the advertising content to the electronic device 100 if the user context analyzed based on the received state information is a context in which advertising content can be provided and the electronic device 100 is in a standby mode.

The memory 220 may store the advertising content to be provided in the standby mode and the advertising content to be provided in the normal mode. For example, as shown in FIG. 4, the memory 220 may store the advertising content including brief information to be provided in the standby mode and the advertising content including detailed information to be provided in the normal mode. The processor 230 may provide the advertising content to be provided in the standby mode to the electronic device 100 through the communicator 210, and if there is a request from the electronic device 100, the processor 230 may provide the advertising content to be provided in the normal mode to the electronic device 100 through the communicator 210. The advertising contents for the normal mode and the advertising contents for the standby mode together may be provided to the electronic device 100, and the electronic device 100 may provide an image corresponding to the corresponding advertising contents according to the mode change.

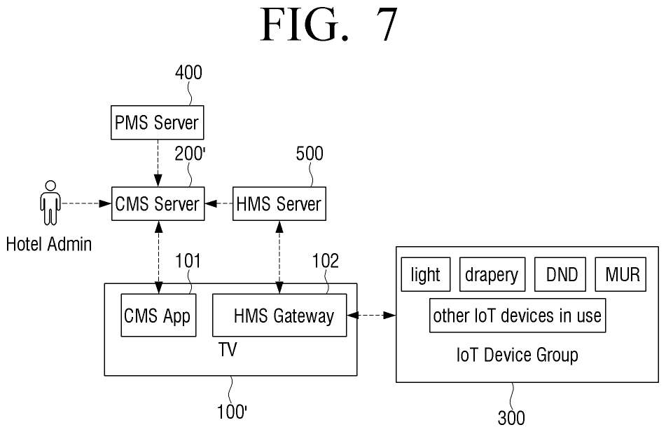

FIG. 7 is a view illustrating an embodiment in which the system according to the disclosure is applied to a hotel.

Referring to FIG. 7, a property management system (PMS) server 400, a content management system (CMS) server 200′, a hospitality management solution (HMS) server 500, a TV 100′, and an IoT device 300 are illustrated. The TV 100′ and the IoT device 300 are disposed in a hotel room.

The CMS server 200′ may be the server 200 described above. Alternatively, the CMS server 200′ and the PMS server 400 may be the server 200 described above. Alternatively, the PMS server 400 and the CMS server 200′ may be the server 200 described above. Alternatively, the PMS server 400, the CMS server 200′, and the HMS server 500 may be the server 200 described above. The TV 100′ may be the electronic device 100 described above.

The PMS server 400 may be in charge of managing information inside a hotel. In the PMS server 400, information on hotel room and properties, gender/nationality, check-in/check-out, payment information, or the like, of a guest may be managed.

The HMS in charge of connection and operation of the IoT device 300 may include the HMS server 500, an HMS gateway 102, and the IoT device 300.

The IoT device 300 transmits the state information to the HMS server 500 in real time through the HMS gateway 102 installed in the TV 100′. The TV 100′ also transmits its state information to the HMS server 500. The HMS server 500 stores the registration information and state information of the TV 100′ and the IoT device 300, and may also control and monitor the operation of the device. The IoT device 300 may include, for example, a lighting device, a drapery sensor, a service requesting device (Do Not Disturb (DND) sign device, a Make Up Room (MUR) sign device, and the like).

The CMS, which is an advertising content management system, is implemented as a CMS server 200′ and a CMS application 101. The hotel manager may connect to the CMS server 200′ to register the advertising content. The CMS server 200′ is capable of communicating with the HMS server 500 and the PMS server 400. The CMS server 200′ may collect state information of the IoT device 300 from the HMS server 500, collect the guest-related information from the PMS server 400, analyze the collected information to determine advertising content, and determine a time for providing the advertising content. The determined guest-customized advertising content may be transmitted to the CMS application 101 running on the TV 100′, and may be exposed at and optimal time that does not hinder the stay experience of the guest.

The TV 100′ may be a smart TV in which the application is installable for installation of the CMS application 101 and the HMS gateway 102. The TV 100′ may be a device having a content reproduction function in a standby mode. The state information of the operating mode of the TV 100′ is also transmitted to the HMS server 500 in the same manner as the IoT device 300. If there is a device capable of replacing a TV function in addition to the TV 100′ in the room, advertising content may be provided through the corresponding device. For example, advertising content may be provided via a smart mirror.

The CMS server 200′ may identify whether data related to the guest-related data of the PMS server 400 and data related to the IoT device 300 of the HMS server 500 are stored in the CMS server 200′. If not, the necessary data is requested to the PMS server 400 and the HMS server 500. The collected data is used to determine advertising content in the CMS server 200′ and to determine the time of providing advertising content. When the advertising content is determined, the CMS server 200′ may analyze the context of the guest in real time to identify whether it is the time that the advertising content may be provided.

The PMS server 400 may, for example, provide the CMS server 200′ with hotel-related information (e.g., type of a hotel, room, type, location of hotel, or the like) about the guest (e.g., gender, nationality, the number of companions, or the like).

The HMS server 500 may provide the state information of the TV 100′ and the IoT device 300 to the CMS server 200′. For example, the HMS server 500 may provide the CMS server 200′ with state information about whether the TV 100′ is in the normal mode, or the standby mode, the state information of the drapery sensor among the IoT device 300, the state information of the lighting sensor, the state information regarding whether the DND sign device is turned on, or the MUR sign device is turned on.

The CMS server 200′ may determine the advertising content based on the data provided from the PMS server 400 and the HMS server 500, and determine the advertising content providing time. For example, the CMS server 200′ may provide advertising contents by dividing 1) a time zone when providing the advertising content is available, 2) a time zone when providing the advertising content is essential, and 3) a time zone when providing the advertising content is prohibited.

In the time zone when providing the advertising content is available, unless it is the time zone when providing the advertising content is prohibited, the advertising content may be provided at the time desired by a hotel manager. For example, the time zone when providing advertising content is available may be from the time when the guest wakes up to the time when the guest goes to bed. If the TV 100 is in the standby mode, the lighting device is on or the drapery is opened, and if the current time is between 5 AM and 11 AM, the CMS server 200′ may identify that the user context is wake-up in the morning. If the TV 100 is in the standby mode, the lighting device is turned off, and the current time is between 8 PM and 5 AM, the CMS serve 200′ may identify that the user context is going to bed.

The time when providing an advertisement content is essential may be, for example, a context that the guest is about to go out. The CMS server 200′ may identify that the user context is that the guest is about to go out, when the TV 100 is in the standby mode and the MUR sign device is turned on.

The time when providing the advertising content is prohibited may be, for example, a context where the guest wishes to take a rest. If the DND sign device is turned on, the CMS server 200′ may identify that the user context is a DND context, and in this context, the advertising content is not provided to the TV 100′.

As described above, the time of providing the advertisement may be changed by a hotel manager. For example, if the hotel manager wishes, it is possible to provide an advertising content even it is the time when providing the advertising content is prohibited.

At a later time, a specific context may be added at the time of providing the advertising contents if the data for analyzing a guest context is increased. For example, as guest room door sensor is included in the IoT device 300 and registered in the HMS system as a new device, it may be possible to grasp the time of entering and returning to the room of the guest, and the context of immediately after returning to the room may be added to the time when providing the advertising content is essential.

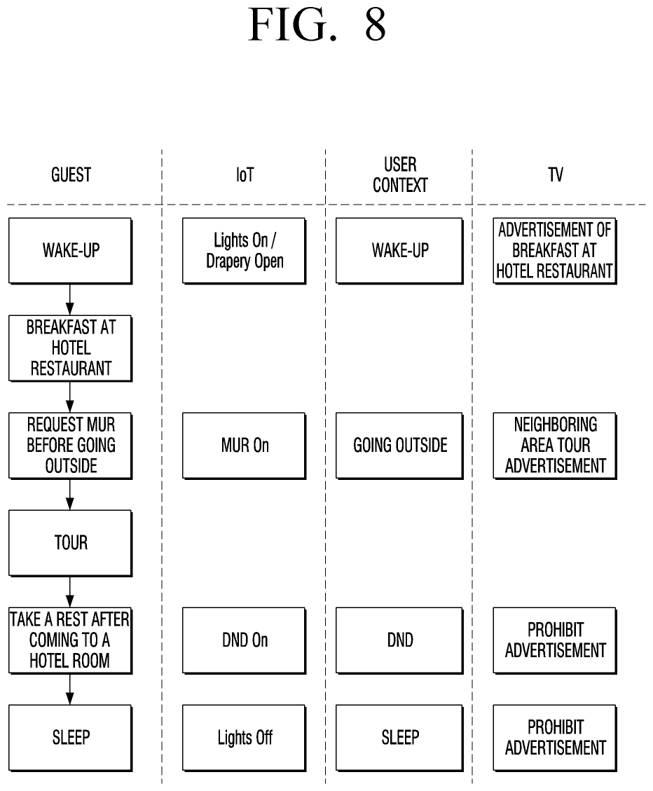

FIG. 8 is a view illustrating a time of providing an advertising content according to a behavior of a guest.

Referring to FIG. 8, if the guest wakes up in the morning, turns on the lighting, and opens the drapery, the CMS server 200′ may determine that the user context is wake-up, and provides the morning meal advertising content at a hotel restaurant to the TV 100′ so that the TV 100′ may provide an image corresponding to the corresponding advertising content. When the guest turns the MUR sign device to request the room cleaning just before going out, the CMS server 200′ may identify that the user context is just before going out and provide the advertising content related to the tour around the hotel so that the TV 100′ may provide an image corresponding to the advertising content. The CMS server 200′ may provide an advertisement based on the personal information of the user. For example, if the user has a history of enjoying surfing when the user visits the hotel in the past, the CMS server 200′ may provide the advertising content related to the surfing to the TV 100′. When the guest finishes the tour and returns to the room and then turns on the DND sign device, the CMS server 200′ may identify that the user context is a DND and may not provide advertising content to the TV 100′. If the user turns the lighting off at the evening time zone, the CMS server 200′ may identify that the user context is sleeping, and may not provide the advertising content to the TV 100′.

According to an embodiment, the hotel guest may have a benefit by obtaining necessary information at a current time without being hindered with a stay experience, and a hotel may provide a customized advertisement at a desired time through a state determination for the hotel guest, thereby expecting a sales increase.

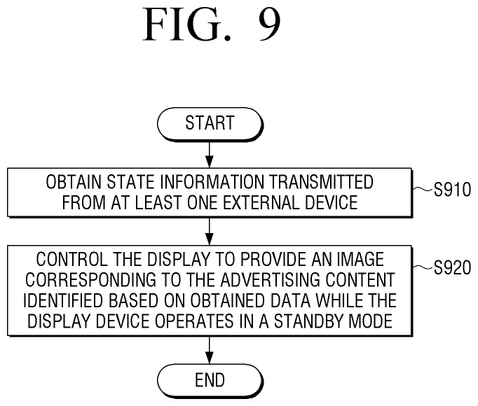

FIG. 9 is a flowchart illustrating a method of controlling an electronic device according to an embodiment. The flowchart as illustrated in FIG. 9 may consist of operations that are processed in the electronic device 100 or TV 100′ described herein. Accordingly, the description of the electronic device 100 or the TV 100′ may be applied to the flowchart shown in FIG. 9 even though the description is omitted below.

Referring to FIG. 9, the state information transmitted by at least one external device is obtained in operation S910.

The display of the electronic device is controlled to provide an image corresponding to the advertising content determined on the basis of the obtained state information while the electronic device is operating in the standby mode in operation S920.

The advertising content may be pre-stored in the electronic device, or provided from an external server. In order to receive advertising content from an external server, the controlling method may further include the step of providing the obtained state information to an external server. When the advertising content determined based on the obtained state information is received from the external server, the display may be controlled to provide an image corresponding to the received advertising content.

In this example, an image corresponding to the advertisement content may be provided through the display at a time determined by the external server based on the obtained state information.

The advertising content may be advertising content corresponding to the determined user context by analyzing the state information obtained by the external server. Alternatively, the advertising content may be determined based on the obtained state information and personal information of the user of the electronic device,

When a preset user input is received while the electronic device provides an image corresponding to advertising content through the display in the standby mode, the electronic device may be switched to the normal mode, and the display may be controlled to provide another image corresponding to the advertising content in the normal mode.

In this example, the standby mode may be a mode to provide an image corresponding to the advertising content with power lower than the normal mode.

The image corresponding to the advertising content provided in the standby mode may include brief information about the advertising content, and another image corresponding to the advertising content provided in the normal mode may include detailed information about the advertising content.

The image corresponding to the advertising content provided by the electronic device in the standby mode may include an icon, and as the icon is selected, the standby mode may be switched to the normal mode.

The at least one external device connected to the electronic device may include at least one device selected from the group consisting of a door sensor, a motion sensor, a temperature sensor, an illuminance sensor, a humidity sensor, a drapery sensor, a gas sensor, a lighting device, and a hotel service request device.

According to embodiments described above, providing an advertisement at a time not wanted by a user may be provided, and the user may be benefitted by obtaining advertisement information necessary at the current time. Accordingly, an advertiser may expect a sales increase.

The various example embodiments described above may be implemented in a recordable medium which is readable by computer or a device similar to computer using software, hardware, or the combination of software and hardware. By hardware implementation, the embodiments of the disclosure may be implemented using, for example, and without limitation, at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electric units for performing other functions, or the like. According to a software implementation, embodiments such as the procedures and functions described herein may be implemented with separate software modules. Each of the above-described software modules may perform one or more of the functions and operations described herein.

The computer instructions for performing the processing operations of the electronic device 100 according to the various embodiments described above may be stored in a non-transitory computer-readable medium. The computer instructions stored in this non-transitory computer-readable medium may cause the above-described specific device to perform the processing operations in the electronic device 100 according to the above-described various example embodiments when executed by the processor of the device.

For example, it may be provided a non-transitory computer-readable medium storing computer instructions that, when executed by a processor of a particular device, cause the particular device to obtain state information transmitted by at least one external device and control a display of the electronic device to provide an image corresponding to advertising content determined based on the obtained state information while the electronic device is operating in the standby mode.

Computer instructions for executing the processing operations at the server 200 according to various embodiments described above may be stored in a non-transitory computer-readable medium. The computer instructions stored in the non-transitory computer-readable medium, when executed by a processor of a particular device, cause the particular device to perform the processing operations at the server 200 according to the various embodiments described above.

The non-transitory computer readable medium may refer, for example, to a medium that stores data semi-permanently, and is readable by an apparatus. For example, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like.

According to an embodiment, the method according to various embodiments disclosed herein may be provided in a computer program product. A computer program product may be exchanged between a seller and a purchaser as a commodity. A computer program product may be distributed in the form of a machine-readable storage medium (e.g., compact disc read only memory (CD-ROM)) or distributed online through an application store (e.g. PlayStore™). In the case of on-line distribution, at least a portion of the computer program product may be stored at least temporarily in a storage medium such as a manufacturer's server, a server of an application store, or a memory of a relay server or temporarily generated.

The foregoing example embodiments and advantages are merely examples and are not to be understood as limiting the disclosure. The present disclosure may be readily applied to other types of devices. The description of the embodiments of the disclosure is intended to be illustrative, and not to limit the scope of the claims, and many alternatives, modifications, and variations will be apparent to those skilled in the art.

What is claimed is:

1. An electronic device comprising:
a display;
a communicator;
a memory configured to store computer executable instructions; and
a processor configured to execute computer executable instructions so as to obtain, through the communicator, state information transmitted by at least one external device, and control the display to provide, while the electronic device operates in a standby mode, an image corresponding to an advertising content determined based on the obtained state information.

2. The electronic device of claim 1, wherein the processor is further configured to provide, through the communicator, the obtained state information to an external server, and based on receiving the determined advertising content from the external server based on the obtained state information, control the display to provide an image corresponding to the received advertising content.

3. The electronic device of claim 2, wherein the image corresponding to the advertising content is provided through the display at a time determined by the external server based on the obtained state information.

4. The electronic device of claim 2, wherein the advertising content corresponds to a user context determined by analyzing the obtained state information by the external server.

5. The electronic device of claim 1, wherein the processor is further configured to, based on receiving a preset user input while the image corresponding to the advertising content is provided through the display, switch the electronic device to a normal mode and control the display to provide other image corresponding to the advertising content.

6. The electronic device of claim 5, wherein the standby mode is configured to provide an image corresponding to the advertising content with lower power than the normal mode.

7. The electronic device of claim 5, wherein:
the image corresponding to the advertising content provided in the standby mode comprises brief information for the advertising content, and
other image corresponding to the advertising content provided in the normal mode comprises detailed information for the advertising content.

8. The electronic device of claim 5, wherein:
the image corresponding to the advertising content provided in the standby mode comprises an icon, and
the processor is configured to, based on the icon being selected, switch the electronic device to a normal mode, and control the display to provide the other image corresponding to the advertising content.

9. The electronic device of claim 1, wherein the at least one external device comprises at least one device selected from a group consisting of a door sensor, a motion sensor, a temperature sensor, an illuminance sensor, a humidity sensor, a drapery sensor, a gas sensor, a lighting device, and a device for requesting a hotel service.

10. The electronic device of claim 1, wherein the advertising content is determined based on personal information of a user of the electronic device.

11. A control method of an electronic device, the method comprising:
obtaining state information transmitted by at least one external device; and
controlling a display of the electronic device to provide, while the electronic device operates in a standby mode, an image corresponding to an advertising content determined based on the obtained state information.

12. The method of claim 11, further comprising:
providing the obtained state information to an external server, and
wherein the controlling the display comprises, based on receiving the determined advertising content from the external server based on the obtained state information, controlling the display to provide an image corresponding to the received advertising content.

13. The method of claim 12, wherein the image corresponding to the advertising content is provided through the display at a time determined by the external server based on the obtained state information.

14. The method of claim 12, wherein the advertising content corresponds to a user context determined by analyzing the obtained state information by the external server.

15. The method of claim 11, further comprising:
based on receiving a preset user input while the image corresponding to the advertising content is provided through the display, switching the electronic device to a normal mode; and
controlling the display to provide other image corresponding to the advertising content in the normal mode.
